(19) United States
(12) Patent Application Publication
(10) Pub. No.: US 2026/0013450 A1
(43) Pub. Date: Jan. 15, 2026

(54) Adjustable Multi-Port Irrigation Manifold System with Smart Control Interface

(71) Applicants: Donald T. McGrath, Colorado Springs, CO (US); Alexander Wilson, Colorado Springs, CO (US); Zachary Bachofner, Colorado Springs, CO (US); Joseph Gysbers, Colorado Springs, CO (US); Zachary Wagner, Colorado Springs, CO (US); Louis R Price, Colorado Springs, CO (US)

(72) Inventors: Donald T. McGrath, Colorado Springs, CO (US); Alexander Wilson, Colorado Springs, CO (US); Zachary Bachofner, Colorado Springs, CO (US); Joseph Gysbers, Colorado Springs, CO (US); Zachary Wagner, Colorado Springs, CO (US); Louis R Price, Colorado Springs, CO (US)

(21) Appl. No.: 19/333,387

(22) Filed: Sep. 19, 2025

Related U.S. Application Data
(63) Continuation-in-part of application No. 18/661,664, filed on May 12, 2024.

(51) Int. Cl. A01G 25/16; A01G 25/00

(52) U.S. Cl. CPC A01G 25/165; A01G 25/006

(57) ABSTRACT

An intelligent, programmable irrigation manifold system is disclosed, comprising a modular housing with multiple emitter ports, each independently controlled by a latching solenoid valve. The system interfaces with standard drip irrigation infrastructure and enables user-defined water delivery per port via a mobile application. A microcontroller governs valve actuation based on stored schedules and environmental parameters, while an integrated wireless module facilitates remote configuration and firmware updates. The system operates on solar or USB power and includes a pressure-based wake-up mechanism for energy efficiency. Designed for both retrofit and new installations, the device delivers precise irrigation to heterogeneous plant species, reducing overwatering and promoting sustainable landscaping practices. Optional integration with auxiliary sensors and weather data enables dynamic adjustment of irrigation protocols. Scalable across residential and commercial installations, the system provides individualized plant hydration management through a smart, connected interface.

### BACKGROUND OF THE INVENTION

### Field of Invention

The present invention relates generally to irrigation systems and, more particularly, to an adjustable, programmable, and modular drip irrigation manifold designed for use in residential, commercial, or agricultural settings. The invention enables precision-controlled water distribution to multiple plant species with varying hydration requirements via a smart, app-based control interface.

### BRIEF SUMMARY OF THE INVENTION

The invention disclosed herein is directed to an intelligent irrigation device known as the Set N' Soak™ manifold system. This system comprises a modular manifold with multiple adjustable emitter ports, each configured to deliver a programmable and metered quantity of water to a specific plant or group of plants. The manifold is retrofittable to existing drip irrigation systems and incorporates a microcontroller, latching solenoid valves, power management circuitry (including solar and wired options), and wireless communication hardware for remote operation. The device is operable through a mobile application that allows for user-defined irrigation schedules and volumes, tailored to individual plant requirements based on species, soil type, maturity, and environmental factors. Optional sensor inputs allow for further automation based on moisture level, pH, and other parameters. The invention addresses inefficiencies and waste associated with traditional drip irrigation systems and offers a scalable, cost-effective, and user-friendly solution to dynamic plant watering needs.

### BRIEF DESCRIPTION OF THE FIGURES

FIG. 1 illustrates the complete smart irrigation cycle of the Set N' Soak™ system, beginning with pressure detection and wireless connection initialization (FIGS. 1.101 and 1.103), proceeding through irrigation schedule retrieval and precision valve actuation (FIGS. 1.105 and 1.107), followed by targeted water dispensing and real-time sensor logging (FIGS. 1.109 and 1.111), and concluding with system sleep reentry and cloud data synchronization (FIG. 1.113).

FIG. 2 illustrates the integration of the Set N' Soak™ device into a multi-zone drip irrigation system, coordinated by a system clock and wirelessly managed via a networked control interface.

FIG. 3 depicts the internal architecture of the Set N' Soak™ device, detailing the water reservoir, solenoid-actuated emitter outputs, power supply components, and the microcontroller-based control logic.

FIG. 4 shows the mechanical housing of the Set N' Soak™ unit, including external ports, dimensional specifications, and an example of an in-field deployment.

FIG. 5 presents the mobile application interface for the Set N' Soak™ system, showing multi-device configuration, irrigation scheduling, zone-specific volume settings, and port-level diagnostics.

### DETAILED DESCRIPTION

The present invention discloses an advanced modular irrigation apparatus herein referred to as the Set N' Soak™ Manifold System. The invention is engineered to integrate seamlessly within conventional low-pressure drip irrigation infrastructure, such as systems employing ½ inch to 1 inch PVC or polyethylene tubing with an operational pressure range between approximately 10 psi and 50 psi. The structural configuration of the Set N' Soak™ unit is designed to be compact, scalable, and field-deployable, with adaptability for both new installations and retrofit applications.

The manifold housing comprises a durable, weather-resistant enclosure, fabricated from UV-stabilized polymeric material capable of withstanding prolonged exposure to outdoor environmental conditions, including fluctuations in temperature, moisture, and solar radiation. The enclosure is approximately 6 inches in length, 3 inches in width, and 2 inches in height in its current embodiment, although dimensional tolerances may vary depending on final production requirements. The housing may be manufactured using injection-molded thermoplastics, thermoset composites, or similar structural materials, and may optionally include gaskets, O-rings, or other sealing elements to ensure ingress protection consistent with IP65 or greater standards.

The inlet port of the manifold is designed for hydraulic connectivity to a pressurized irrigation feed line via either a barbed, threaded, or compression fitting, depending on regional standards and installer preference. The manifold includes six (6) independent outlet ports, each of which is configured to receive ¼ inch drip tubing commonly used in emitter delivery lines. Each outlet port is internally plumbed to a discrete flow path governed by an electronically actuated latching solenoid valve, thereby providing per-port control of irrigation volume and timing.

Internally, the manifold is subdivided into a primary flow chamber, through which the input water is directed, and multiple secondary channels, each corresponding to one of the six emitter ports. These secondary channels are physically segregated and include integrated flow calibration features—such as orifice plates, venturi sections, or restrictor fittings—to facilitate pressure equalization and predictable flow performance. The design anticipates an operational flow range of approximately 0 to 5 gallons per hour (GPH) per port, adjustable in predefined increments (e.g., 0.5 GPH), although this may be governed dynamically via the control circuitry as further described in subsequent sections.

Affixed within the housing is a mounting platform or chassis onto which the various electronic and electromechanical components are secured. This internal architecture enables field servicing or modular replacement of individual components such as valves or circuit boards. The housing further incorporates a dedicated compartment or mounting area for a power subsystem, which may include a solar photovoltaic (PV) cell array mounted externally on the housing's upper surface, a rechargeable lithium-ion or lithium-iron-phosphate battery, and a wired USB input for auxiliary or maintenance charging.

Mechanical design also considers mounting adaptability. The manifold may include integrally molded clips, brackets, or fastening holes for attachment to stakes, posts, risers, or other landscape infrastructure. The manifold is designed to remain stable regardless of orientation during operation to avoid positional bias in flow delivery.

To facilitate quick field deployment, in some embodiments the Set N' Soak™ device may incorporate a “T” connection module. The T-connector is designed to insert inline between segments of a mainline or lateral line and redirect a portion of the flow to the manifold, which in turn dispenses water to downstream emitter tubing.

The unit's structural configuration prioritizes redundancy and failsafe operation. Each valve is independently addressable and, in the event of electronic failure or pressure loss, designed to return to a default closed state, thereby preventing uncontrolled water discharge. Furthermore, the enclosure design accommodates expansion to additional ports or sensors in future iterations, including moisture probes or environmental feedback loops, through pre-formed knockouts or auxiliary connector bays.

The Set N' Soak™ manifold system represents a mechanically robust and highly adaptable irrigation architecture, precisely engineered to deliver individualized hydration volumes in an efficient, scalable, and user-configurable form factor.

The Set N' Soak™ manifold system incorporates an advanced fluid distribution architecture comprising a hydraulically isolated multi-channel flow delivery mechanism, wherein each channel is independently regulated by an electronically actuated latching solenoid valve. The fluid distribution subsystem is engineered to optimize water resource efficiency by enabling precise, volumetric control over irrigation output at each emitter port, thereby accommodating heterogeneous watering requirements across a diverse plant landscape.

At the core of the mechanism lies a multi-port valve matrix, wherein each of the six (6) output ports is fluidly connected to a distinct internal conduit. Said conduits originate from a centralized pressurized input chamber that receives flow from a main drip irrigation line. The internal hydraulic topology ensures that no two emitter lines share an uncontrolled fluid path, thus allowing for isolated and programmable flow control on a per-port basis. Each conduit is equipped with a microfluidic regulation system governed by a low-power latching solenoid valve. These valves are configured in a normally closed state and are selectively actuated under microcontroller direction to open for pre-calculated durations sufficient to deliver the desired water volume.

The latching solenoid valves are pulse-actuated, thereby eliminating the need for continuous current draw during operation. This enhances energy efficiency and allows the manifold to operate under low-voltage solar or battery-based power sources. Upon receipt of an actuation signal, each valve opens to permit flow through its associated conduit and subsequently closes either after a predetermined time interval or upon confirmation of target volume delivery, as determined by software control algorithms. In some embodiments, the system may further incorporate inline flow restrictors, precision-milled nozzle inserts, or sprayers or bubblers downstream of each solenoid valve to ensure consistent flow rate characteristics regardless of upstream pressure fluctuations.

Each valve's actuation schedule and flow duration are computed based on an internal mapping table or external user input via the smart application interface. Said input may be derived from plant species data, soil characteristics, evapotranspiration models, or historical watering profiles. Water volume per emitter port is programmable from 0 gallons to 5 gallons per irrigation cycle, in configurable increments (e.g., 0.5 gallons). This range supports a wide spectrum of use cases, from micro-irrigation of sensitive perennials to deep watering of mature trees.

The device includes an optional internal pressure transducer located proximal to the main input line, configured to detect the presence of active hydraulic pressure and initiate the manifold's operational cycle accordingly. This sensor serves as both a wake-up trigger for the control electronics and as a safety check to confirm that adequate line pressure exists to perform a reliable irrigation event. In alternative embodiments, the pressure transducer may be supplemented or replaced with a capacitive or ultrasonic flow sensor for closed-loop verification of water delivery per port.

The manifold also supports a test mode, wherein each port may be opened sequentially for visual verification, system calibration, or maintenance flushing. During test mode, pressure input may be simulated or bypassed, allowing system installers to confirm emitter functionality in the absence of active line pressure. This functionality is especially useful during the initial setup or seasonal reactivation of the irrigation system.

Water exiting each emitter port is directed through ¼ inch quick connect fittings compatible with standard drip tubing. The system is designed to support either point-source emitters at the plant base or spaghetti tubing leading to micro-sprinklers or bubblers. The volumetric precision offered by the fluid distribution mechanism allows for differential watering of distinct plant zones, thereby reducing overwatering, nutrient leaching, and root rot.

In addition to the programmable logic governing fluid delivery, the manifold includes internal diagnostics capable of detecting valve actuation failure, blockage conditions, or anomalous flow durations. These diagnostics may be reported via the app interface or logged for periodic review. Such features serve to minimize downtime, optimize long-term irrigation performance, and enhance the operational reliability of the overall landscape management system.

Accordingly, the fluid distribution control mechanism disclosed herein enables an unparalleled degree of irrigation granularity, system responsiveness, and ecological responsibility, facilitating sustainable landscaping practices and maximizing plant health through targeted water delivery.

The Set N' Soak™ manifold system is equipped with an embedded control subsystem comprising a low-power microcontroller unit (MCU), solenoid valve drivers, pressure-activated wake circuitry, and an integrated power management module. This subsystem orchestrates the selective activation of solenoid-controlled emitter ports, manages wireless communication functions, and oversees autonomous operation in response to external irrigation triggers and programmed schedules.

At the center of the control architecture resides a microcontroller, preferably a 32-bit ultra-low-power unit with embedded flash memory and real-time clock functionality. Suitable examples include microcontrollers from the STM32, ESP32, or Nordic nRF series, depending on performance and power consumption constraints. The MCU is programmed with firmware that maintains emitter port configurations, stores scheduling logic, communicates wirelessly with external devices, and supervises valve actuation with high temporal precision.

Each of the six (6) internal solenoid valves is coupled to a dedicated solenoid driver circuit, typically implemented using H-bridge or full-bridge topology suitable for latching solenoids. These drivers provide bidirectional current pulses to magnetically actuate the valve core, toggling between open and closed states without sustained current draw. The inclusion of flyback diodes or similar clamping mechanisms ensures safe suppression of inductive voltage spikes during valve switching, thereby protecting sensitive control electronics.

The system features a pressure-sensing wake trigger, which may include a piezoresistive pressure sensor or an alternative solid-state transducer embedded in proximity to the main inlet line. This sensor continuously monitors hydraulic pressure and signals the MCU to exit sleep mode upon detection of an irrigation cycle initiation, typically characterized by line pressure exceeding a defined threshold (e.g., >10 psi). This feature eliminates the need for an always-on processor state, thereby dramatically reducing idle power consumption and extending operational battery life.

The power management module is bifurcated into two functional layers: energy harvesting and energy storage. The primary energy input is derived from a solar photovoltaic (PV) array connected to the device's housing. This array is constructed from monocrystalline or polycrystalline silicon cells, selected for outdoor durability and high conversion efficiency under partial shade conditions. The harvested energy is routed through a maximum power point tracking (MPPT) charge controller to regulate charge flow into a rechargeable lithium-ion battery, typically in the 3.7-4.2V range with a nominal capacity sufficient for multiple irrigation cycles without solar input (e.g., ≥2000 mAh).

Secondary or auxiliary power may be supplied via a wired USB interface, or 24 volts AC, for example, allowing for manual charging, firmware updates, or debugging during development or installation phases. The USB port may also serve as a data bridge for direct configuration in the absence of wireless connectivity.

An onboard power conditioning circuit manages regulated voltage rails for the microcontroller, wireless module, sensors, and valve drivers. Voltage regulators may include low dropout (LDO) or buck-boost converters to maintain constant supply levels under variable input conditions. Power domains are segregated using logic-level shifters and gating switches to isolate high-current components from sensitive control electronics, thereby enhancing operational stability.

The firmware architecture supports various low-power modes, including deep sleep, idle, and sensor-only polling states. The system remains in quiescent mode with all nonessential components de-energized until a pressure event or scheduled trigger activates the main processor. Following the completion of an irrigation cycle, the MCU commits telemetry data to non-volatile memory, transmits logs (if applicable), and re-enters sleep mode.

The wireless module is powered independently through the power management system and includes startup and shutdown sequences synchronized with MCU activity. This ensures that communication functions are activated only when required, preserving energy and reducing RF emissions in compliance with regional communication standards (e.g., FCC Part 15).

Environmental protection measures are also implemented within the control system. The printed circuit board (PCB) is conformally coated to protect against humidity, insect ingress, and thermal cycling. All external connectors are fitted with gaskets or weatherproof seals, and all enclosure openings are designed to maintain a minimum IP65 rating.

Collectively, the embedded control electronics and power management subsystems form the operational backbone of the Set N' Soak™ device, enabling autonomous, intelligent, and energy-efficient irrigation control with minimal user intervention and prolonged field durability.

The Set N' Soak™ manifold system includes a sophisticated wireless communication interface that enables seamless interaction between the irrigation hardware and a user-operated software application. This bidirectional interface facilitates real-time configuration, monitoring, scheduling, and diagnostic functions. The wireless subsystem is engineered in accordance with contemporary Internet of Things (IoT) design paradigms and is compatible with existing home and commercial wireless networks, thereby enabling remote and programmable irrigation management with high spatial and temporal resolution.

The wireless interface is supported by a dedicated radio-frequency (RF) module, which may utilize Wi-Fi (IEEE 802.11b/g/n), Bluetooth Low Energy (BLE 5.0), or other wireless standards such as Zigbee or LoRaWAN, depending on deployment topology and power budget constraints. In residential deployments with ubiquitous Wi-Fi coverage, a 2.4 GHz Wi-Fi chipset is preferred for its high data throughput and integration with conventional smart home ecosystems. In low-power or large-area installations, sub-GHz long-range protocols (e.g., LoRa) may be deployed to facilitate mesh networking across multiple manifold units.

Each Set N' Soak™ device is addressable within the application ecosystem via a unique digital identifier (e.g., MAC address or device UUID), allowing users to manage multiple devices across different zones or properties. Upon initial power-up or installation, the device enters a provisioning mode, during which it exposes a temporary wireless access point or Bluetooth beacon. This enables secure onboarding via the mobile or desktop application, which guides the user through network authentication, device naming, and initial configuration steps.

Once network-connected, the device is capable of receiving user-defined irrigation schedules, which are stored in the internal non-volatile memory of the microcontroller and executed autonomously. Each of the six emitter ports may be individually programmed via the application to deliver a specific water volume on a time-based schedule, such as daily, weekly, or variable intervals based on seasonal requirements. The application allows volumetric input in gallons or liters, with default increments of 0.5 gallons, and may also support lookup-based volume recommendations derived from plant type and location.

The smart application includes an intuitive user interface (UI), typically rendered as a mobile app for iOS and Android platforms. Through the UI, users can assign labels to each port (e.g., “Front Maple Tree,” “Rose Bed,” “Succulent Planter”), view historical watering logs, and receive alerts in the event of fault conditions (e.g., valve failure, low battery, excessive watering duration). The application may also interface with cloud-based analytics engines to provide performance reports and system health diagnostics.

In preferred embodiments, the application integrates with environmental data sources, including regional weather APIs, soil moisture sensors, and evapotranspiration indices. By correlating this data with plant-specific watering needs, the software may dynamically adjust irrigation schedules to reduce water usage during rainy periods or increase it during high heat or drought conditions. The system architecture supports such dynamic reprogramming via over-the-air (OTA) firmware updates and real-time data synchronization between the mobile app and the embedded controller.

Additionally, the application incorporates security protocols, including encrypted communication (e.g., TLS/SSL), device authentication, and optional two-factor authorization to prevent unauthorized access or malicious configuration. Firmware updates may be remotely pushed to the device through the same secure wireless channel, ensuring that performance enhancements or security patches can be deployed without physical access to the manifold.

Advanced modes within the application may support AI-driven optimization, where users upload plant images, select species from a database, or input soil characteristics, allowing the app to generate watering schedules based on botanical best practices. These schedules can then be downloaded to each manifold, enabling data-driven irrigation precision.

For commercial or multi-site deployments, the system architecture may be extended to include a centralized dashboard that aggregates data from numerous Set N′ Soak™ units across properties or zones. This feature is beneficial for landscape contractors, property managers, or municipal installations seeking to manage hundreds of plant clusters from a single interface.

Overall, the smart wireless interface and application integration transform the Set N' Soak™ manifold from a passive hardware device into an intelligent, cloud-connected platform capable of adaptive, sustainable, and user-centric irrigation management. By leveraging modern communication protocols and user-friendly software design, the invention achieves a high degree of configurability and automation, setting a new standard in precision landscape irrigation.

The Set N' Soak™ manifold system is architected for both micro-level configurability and macro-level scalability, enabling its deployment in a wide spectrum of irrigation scenarios ranging from single-family residential gardens to expansive commercial and municipal landscapes. The modularity of the device, combined with its programmable fluidic and electronic architecture, facilitates granular control of localized irrigation while supporting aggregation into larger system topologies governed by centralized or distributed management interfaces.

At its foundational level, each Set N' Soak™ unit functions as an autonomous node capable of managing water distribution across six individually addressable emitter ports. This inherent capacity enables a single device to serve a cluster of up to six trees, shrubs, or perennial beds with independently tunable water delivery profiles. In typical residential configurations, three to ten units may be installed across a landscape, each responsible for a designated plant zone. Installation is performed inline with existing irrigation tubing using a standardized T-connector interface, ensuring retrofittability without significant infrastructural modification.

Scalability is achieved via network topology design that allows for multiple Set N' Soak™ devices to operate concurrently under unified or discrete control schemes. In Wi-Fi or mesh-based deployments, each device may be registered to a single cloud account or administrative console, allowing users to coordinate watering schedules across zones, group similar plant types for simultaneous irrigation, or stagger operation to reduce peak water draw. For high-density installations—such as those on commercial estates, golf courses, or municipal parks—the system supports network segmentation, where devices are grouped by zone IDs or geographical location tags within the software interface.

The architecture is further extensible via integration with auxiliary sensors and environmental inputs. Optional analog or digital sensor ports may be provisioned to accommodate moisture probes, temperature sensors, pH monitors, or flow meters. These sensors provide real-time data to the onboard microcontroller, which may adjust watering schedules dynamically or transmit sensor readings to the user interface for review. In alternative embodiments, third-party smart weather stations or cloud-based weather APIs can be used to preemptively delay watering cycles in anticipation of rainfall or modify irrigation durations based on regional evapotranspiration trends.

Use cases for the Set N' Soak™ system extend beyond traditional lawn and garden applications. In arid or water-restricted regions, the system can be used to implement precision xeriscaping, where diverse drought-tolerant plant species with disparate watering tolerances are managed from a single manifold using tailored volume outputs. In greenhouse environments, the unit's low-voltage and modular characteristics make it suitable for bench-scale irrigation of research plots or specialty crop trials, wherein repeatability and fine-grained control are essential. Agricultural smallholders may use the device for subsurface drip irrigation (SDI) applications where root-zone watering and minimal surface evaporation are desirable.

From a development roadmap perspective, future iterations of the Set N' Soak™ system contemplate integrated machine learning capabilities that continuously adapt watering protocols based on plant health metrics, user behavior, and climatic shifts. Such features may leverage convolutional neural networks trained on plant image datasets to correlate foliage discoloration or wilting with under- or over-irrigation events. In such embodiments, the user may simply photograph a plant, and the system would infer an optimized irrigation strategy based on image analysis and historical patterns.

Moreover, smart assistant integration (e.g., compatibility with Amazon Alexa, Google Assistant, or Apple Homekit) is envisioned to allow for voice-activated control and real-time system queries. This feature will enable users to inquire about watering status (“Did the roses get watered today?”), request immediate action (“Water the backyard trees now”), or receive alerts (“You have a leak in Zone 3”).

Future hardware enhancements under consideration include expansion modules to support additional emitter ports per unit, rapid-deployment clamps for high-pressure systems, and ruggedized enclosures suitable for harsh climates. These additions will allow the Set N' Soak™ platform to enter broader markets, including horticultural export facilities, reforestation projects, and disaster recovery plantings.

Sustainability considerations are embedded in the design philosophy. By enabling targeted water application, the system directly contributes to conservation goals by reducing runoff, eliminating oversaturation, and optimizing irrigation timing. The use of solar energy and recyclable materials in the device housing further aligns with environmental stewardship practices.

The Set N' Soak™ manifold system is not merely an irrigation device but a scalable, intelligent, and future-ready irrigation infrastructure platform. It unites the disciplines of hydraulic engineering, embedded systems, wireless communication, and sustainable landscaping into a cohesive, extensible system capable of transforming traditional irrigation practices across multiple market verticals.

### Detailed Description of Figures

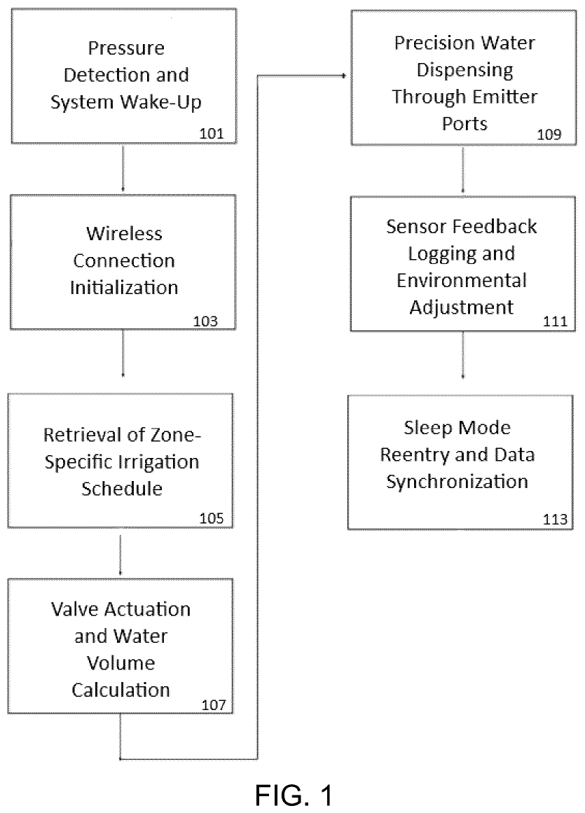

### FIG. 1.101—Pressure Detection and System Wake-Up

Upon the commencement of an irrigation event initiated by the main line controller or system clock, hydraulic pressure is introduced into the main irrigation tubing. A pressure sensor embedded within the Set N' Soak™ manifold detects a threshold pressure level—typically exceeding 10 psi—and generates a wake signal that activates the microcontroller and associated control electronics from a low-power sleep state. This event initializes the operational cycle of the device and triggers subsequent communication and control protocols.

### FIG. 1.103—Wireless Connection Initialization

Following system wake-up, in embodiments with a wireless connection, the microcontroller initiates a wireless handshake with a pre-authorized access point, such as a home Wi-Fi router or mesh network hub. In other embodiments, there is no wireless connection. Authentication protocols and encrypted communication layers are established, allowing the manifold to confirm network identity, request data updates, or transmit status messages. This connection ensures that the device is able to retrieve the most current irrigation instructions and environmental inputs for adaptive operation. If there is no wireless connection made, a preprogrammed setting is used.

### FIG. 1.105—Retrieval of Zone-Specific Irrigation Schedule

Upon establishing a wireless connection, the system queries its onboard memory or receives real-time input from the cloud-hosted control application to access the current irrigation profile associated with its zone. This profile includes time-based triggers, per-port volumetric requirements, and plant-specific watering tolerances. Additionally, the device may incorporate dynamic adjustments based on weather data, evapotranspiration indices, or soil conditions, which are synchronized from external APIs or local sensors.

### FIG. 1.107—Valve Actuation and Water Volume Calculation

The microcontroller executes the retrieved schedule by issuing timed actuation pulses to individual latching solenoid valves corresponding to each emitter port. Each valve opens for a predetermined duration calculated to deliver the user-defined volume of water, taking into account line pressure and emitter flow rate. The system ensures that water is dispensed within +15% of the target volume, applying flow calibration curves or preprogrammed flow equations as needed.

### FIG. 1.109—Precision Water Dispensing Through Emitter Ports

Water flows from the main inlet through the manifold's internal distribution channels, entering the open solenoid-controlled paths and exiting through one or more of the six emitter ports. Each port is connected to ¼-inch tubing that delivers water directly to a target plant or planting cluster. This architecture supports differentiated flow rates to plants with distinct hydration profiles, allowing for heterogeneity in plant types and spacing without the need for manual emitter adjustment.

### FIG. 1.111—Sensor Feedback Logging and Environmental Adjustment

Optional sensors, including soil moisture, pH, or ambient temperature detectors, relay data to the microcontroller during or immediately after the irrigation cycle. This feedback may be used to log performance parameters, adjust subsequent watering schedules, or trigger exception alerts (e.g., moisture saturation exceeded, flow obstruction detected). Logged data is temporarily stored and scheduled for synchronization with the cloud-based dashboard or mobile application.

### FIG. 1.113—Sleep Mode Reentry and Data Synchronization

Upon completion of the irrigation cycle and cessation of line pressure, the system executes a power-down sequence. Logged data is transmitted wirelessly to the user interface, confirming successful cycle execution and uploading diagnostic information. After communication is confirmed or times out, the device reenters low-power sleep mode, isolating power to all nonessential circuits and awaiting the next pressure-based activation event.

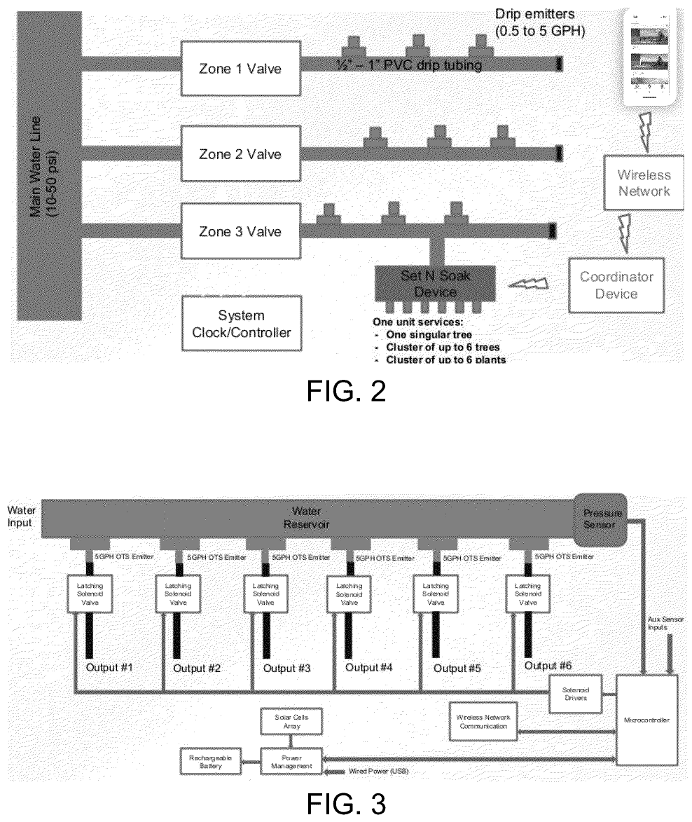

FIG. 2 illustrates a representative implementation of the Set N' Soak™ system integrated within a conventional multi-zone drip irrigation network. A main water line operating at 10 to 50 psi delivers pressurized water to a series of electronically controlled zone valves (Zone 1, Zone 2, Zone 3), which are governed by a system clock or master irrigation controller. Each zone distributes water through ½″ to 1″ PVC drip tubing to a series of emitter devices rated between 0.5 and 5 GPH. The Set N' Soak™ device is depicted as a drop-in unit positioned inline with one of the lateral zone branches. The device features six individually controlled emitter ports, enabling precision water delivery to a single tree, a cluster of up to six trees, or a plant grouping. Wireless connectivity links the manifold to a coordinator device and a cloud-based or local network, enabling smart irrigation scheduling and remote configuration. This diagram captures the manifold's compatibility with legacy systems while highlighting its smart, app-integrated upgrade path.

FIG. 3 details the internal design and functional architecture of the Set N' Soak™ irrigation manifold. The water input channel leads to a common water reservoir that feeds six discrete output paths, each governed by a latching solenoid valve connected to a dedicated 5 GPH off-the-shelf emitter. These valves control Output #1 through Output #6, enabling individual water delivery to up to six separate destinations. Power is supplied via a combination of a solar cell array and a rechargeable battery, regulated by an onboard power management circuit that also supports optional USB wired power. The system is controlled by a microcontroller, which receives sensor data from a pressure sensor and optional auxiliary inputs (e.g., soil moisture or pH sensors). The microcontroller also directs the solenoid drivers and communicates wirelessly with the user interface. The system activates only when water pressure is detected, conserving power while enabling accurate and programmable irrigation cycles.

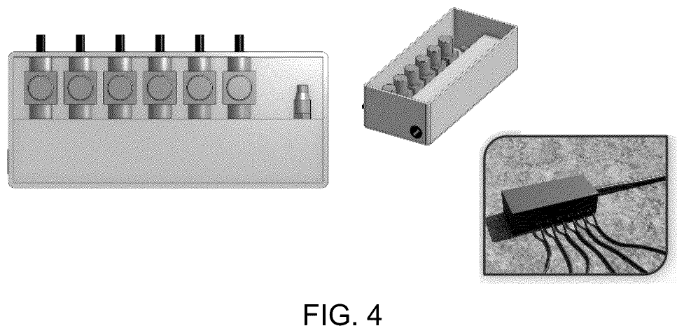

FIG. 4 displays the mechanical and aesthetic aspects of the Set N' Soak™ device enclosure. The design includes six visible adjustment ports aligned across the top face of the unit, representing the manual or electronic interfaces to the internal valves. The device dimensions are variable based on connector requirements. The housing is constructed to accommodate standard ¼″ drip tubing connections and includes weather-sealed access points for power input and wireless antenna routing. The renderings include CAD-based internal visualizations showing the device installed in a landscape setting, connected to multiple drip lines. This enclosure is designed for outdoor durability and simple installation, facilitating both new deployments and retrofits with minimal landscape disruption.

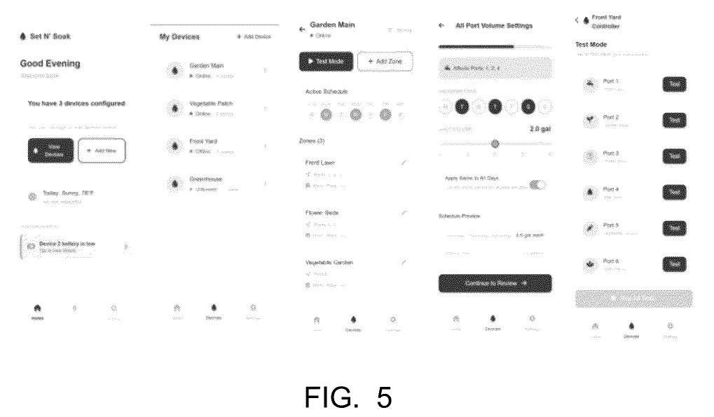

FIG. 5 showcases the mobile application interface that accompanies the Set N′ Soak™ device, highlighting key user interaction features. The first screen displays a dashboard view showing the status of connected devices and current weather information. The second screen presents a list of active devices, including their connectivity and zone count. The third and fourth screens allow for detailed configuration of watering zones, enabling users to assign days of operation, configure daily watering volume (e.g., 2.0 gal), and synchronize settings across multiple ports. The fifth screen shows individual port control within “Test Mode,” where each output can be activated manually for verification purposes. The app supports wireless configuration, real-time diagnostics, firmware updates, and data synchronization, serving as the central interface for intelligent irrigation management. It integrates user-friendly scheduling, zone creation, plant-specific settings, and environmental data inputs into a unified control experience.

What is claimed is:

1. An intelligent irrigation manifold system for use in a drip irrigation network, comprising:
a. a housing having an inlet port configured for fluid communication with a pressurized water source, and a plurality of outlet ports;
b. a plurality of internal fluid conduits, each conduit in fluid communication with the inlet port and a corresponding one of the outlet ports;
c. a plurality of latching solenoid valves, each disposed within a respective conduit and configured to selectively permit or prevent water flow to a corresponding outlet port;
d. a microcontroller operatively coupled to the plurality of latching solenoid valves and configured to actuate each solenoid valve independently based on pre-programmed irrigation parameters;
e. a wireless communication module operatively coupled to the microcontroller, the wireless module configured to receive irrigation schedules and volumetric settings from an external user interface;
f. a power management subsystem comprising at least one solar cell array and a rechargeable battery configured to supply electrical power to the microcontroller, solenoid valves, and wireless communication module;
g. wherein the microcontroller is further configured to initiate an irrigation cycle upon detection of pressurized water at the inlet port, and to deliver a user-defined volume of water through one or more of the outlet ports in accordance with the received irrigation schedule.

2. The system of claim 1, further comprising a pressure sensor disposed in proximity to the inlet port and configured to generate a wake signal to the microcontroller upon detecting a fluid pressure above a predetermined threshold.

3. The system of claim 1, wherein each latching solenoid valve is configured to maintain an open or closed position without continuous electrical power.

4. The system of claim 1, wherein the wireless communication module utilizes a protocol selected from the group consisting of Wi-Fi, Bluetooth Low Energy (BLE), Zigbee, and LoRaWAN.

5. The system of claim 1, wherein the external user interface comprises a mobile application configured to transmit port-specific irrigation settings to the wireless communication module.

6. The system of claim 1, wherein each outlet port is configured to connect to a drip emitter via ¼ inch tubing.

7. The system of claim 1, wherein the microcontroller is configured to deliver between 0 and 4 gallons of water per port during a given irrigation cycle, in user-selectable increments of 0.5 gallons.

8. The system of claim 1, wherein the microcontroller is further configured to operate in a test mode, wherein each outlet port is actuated sequentially regardless of inlet pressure for diagnostic purposes.

9. The system of claim 1, further comprising a printed circuit board (PCB) housed within the housing, the PCB containing the microcontroller, solenoid drivers, and wireless communication module.

10. The system of claim 1, wherein the housing is weather-resistant and sized to fit within a footprint not exceeding 6 inches by 3 inches by 2 inches.

11. The system of claim 1, wherein the external user interface is configured to receive plant-specific irrigation recommendations based on user-provided plant type, soil data, or environmental inputs.

12. The system of claim 1, wherein the microcontroller is configured to receive and apply firmware updates via the wireless communication module.

13. The system of claim 1, further comprising at least one auxiliary sensor input for receiving signals from external environmental sensors selected from the group consisting of soil moisture sensors, pH sensors, and ambient temperature sensors.

14. The system of claim 1, wherein the housing includes an externally accessible USB port configured for supplemental power input or direct configuration.

15. The system of claim 1, wherein multiple said systems are deployable across a distributed irrigation network and are controllable via a centralized interface.
